(19) United States
(12) Patent Application Publication
(10) Pub. No.: US 2014/0310752 A1
(43) Pub. Date: Oct. 16, 2014

(54) SHOPPING IN A MEDIA BROADCAST CONTEXT

(71) Applicants: Selina Lam, Castro Valley, CA (US); Marc Peter Hosein, Saratoga, CA (US)

(72) Inventors: Selina Lam, Castro Valley, CA (US); Marc Peter Hosein, Saratoga, CA (US)

(73) Assignee: EBAY INC., SAN JOSE, CA (US)

(21) Appl. No.: 14/094,617

(22) Filed: Dec. 2, 2013

Related U.S. Application Data
(60) Provisional application No. 61/812,215, filed on Apr. 15, 2013.

(51) Int. Cl. H04N 21/478

(52) U.S. Cl. CPC H04N 21/47815
USPC 725/60

(57) ABSTRACT

A method of allowing a user to shop for items in a media broadcast context is disclosed. It is detected that a user is consuming a media broadcast. Items related to the media broadcast are identified. Correspondences between the identified items and listings of the items on a network-based publication system (e.g., eBay, Amazon.com, or Craigslist) are determined. The user is presented with options to perform actions with respect to the items or listings of the items.

### CROSS-REFERENCE TO RELATED APPLICATIONS

This application claims the benefit of U.S. Provisional Application No. 61/812,215, filed Apr. 15, 2013, entitled “SHOPPING IN A MEDIA BROADCAST CONTEXT,” which is incorporated herein by reference in its entirety.

### BACKGROUND

While consuming (e.g., watching) a media broadcast (e.g., a television show), a user may become interested in items (e.g., products or services) featured in or otherwise associated with the media broadcast (e.g., clothing worn by characters of the media broadcast, tickets to an event associated with the media broadcast, items or props visible within the media broadcast, and so on). However, for various reasons, despite having become interested in an item associated with the media broadcast, the user may not take active steps toward completing a financial transaction pertaining to the items. Such reasons may include the user not being able to exactly identify the items (e.g., by brand), the item being exposed only fleetingly to the user during media broadcast such that the user does not have time to take an active step before the user's attention is diverted away from the item, or the user not being aware that the item is listed on a network-based publication system (e.g., eBay, Amazon.com, or Craigslist) (e.g., as available for purchase from a seller of the item).

### BRIEF DESCRIPTION OF THE DRAWINGS

Some embodiments are illustrated by way of example and not limitation in the figures of the accompanying drawings in which:

FIG. 1 is a network diagram depicting a system within which various example embodiments may be deployed

FIG. 2 is a block diagram illustrating multiple applications that, in various example embodiments, are provided as part of the networked system of FIG. 1.

FIG. 3 is a block diagram illustrating example modules of the media broadcast shopping application(s).

FIG. 4 is a flowchart illustrating an example method of allowing a user to interact with listings associated with items presented within or otherwise associated with a media broadcast.

FIG. 5 is a flowchart illustrating an example method of allowing a user to request feedback from additional users with respect to an action that the user may perform with respect to an item that the user selects in conjunction with a consumption of a media broadcast.

FIG. 6 is a flowchart illustrating an example method of allowing a user to present on a primary device information about an item or a listing of an item received on a secondary device.

FIG. 7 is a flowchart illustrating an example method of allowing a user to present on a primary device information about an item or a listing of an item received on a secondary device.

FIG. 8 is a flowchart illustrating an example method of simultaneously presenting a media broadcast with information about items associated with the media broadcast on a display screen.

FIG. 9 is a flowchart illustrating an example method of presenting a listing of items corresponding to a media broadcast as it relates to a vertical market (e.g., in a sports memorabilia or fashion market) associated with the media broadcast.

FIG. 10 is a flowchart illustrating an example method of simultaneously presenting a media broadcast with information about items associated with the media broadcast on a display screen.

FIG. 11 is a mockup of a user interface that allows a user to simultaneously watch a media broadcast on a first device (e.g., a television) and shop for items related to the media broadcast on a second device (e.g., a tablet PC or smart phone).

FIG. 12 is a mockup of a user interface that allows a user to simultaneously watch a media broadcast on a first device and shop for items related to the media broadcast on a single device (e.g., a tablet PC).

FIG. 13 is a mockup of a user interface that allows a user to shop for items while watching a live sporting event.

FIG. 14 is a block diagram of machine in the example form of a computer system within which instructions for causing the machine to perform any one or more of the operations or methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

Consistent with various embodiments, a method of allowing a user to shop for items in a media broadcast context is disclosed. It is detected that a user is consuming a media broadcast. Items related to the media broadcast are identified. Correspondences between the identified items and listings of the items on a network-based publication system are determined. The user is presented with options to perform actions with respect to the items or listings of the items. For example, the user may be presented with options to place bids on the items, place orders for the items, watch the listings of the items, or perform other operations available to the user with respect to interacting with the items on the network-based publication system. As additional examples, the user may be presented options to view the listings on a primary display (e.g., a television) that is separate from a secondary display (e.g., a tablet PC) on which the user is presented with the options to perform the various actions, or the user may be presented with options to solicit help from additional users with regard to the actions the user should take with respect to the items or start a conversation with the additional users with respect to the items.

This method and various embodiments disclosed herein may be implemented as a computer system having one or more modules (e.g., hardware modules or software modules). This method and various embodiments disclosed herein may be embodied as instructions stored on a machine-readable medium that, when executed by a processor, cause the processor to perform one or more operations.

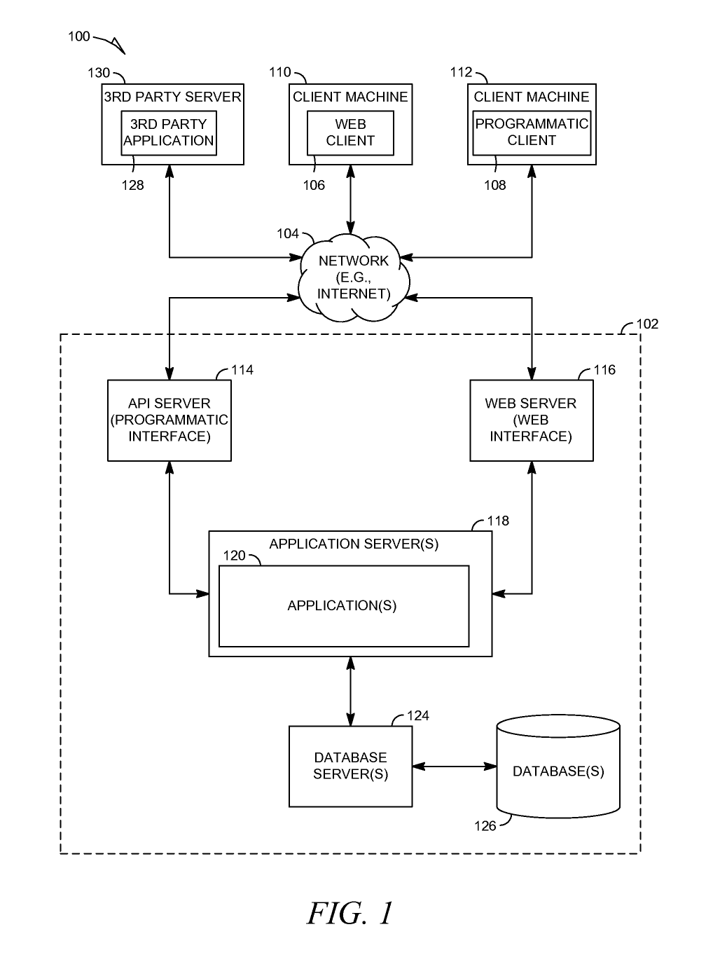

FIG. 1 is a network diagram depicting a system 100 within which various example embodiments may be deployed. A networked system 102, in the example forms of a network-based marketplace or other publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 executing on respective client machines 110 and 112. Each of the one or more clients may include a software application module (e.g., a plug-in, add-in, or macro) that adds a specific service or feature to a larger system. The software application module may be separate from but tightly-integrated into a user interface and functionality of a software application, such as a spreadsheet application. The software application may be a client software application executing on a client machine. The software application module may be optionally deployed in the same environment as the software application such that the software application module can be accessed from within the software application. The software application module may be optionally enabled or disabled within the environment (e.g., user interface) of the software application. The software application module may appear to be a part of the software application by, for example, providing user interface components or widgets (e.g., menus, toolbars, menu commands, toolbar commands, and so on) that can be enabled, disabled, added to, or removed from standard user interface components or widgets provided by the software application.

An API server 114 and a web server 116 are coupled to, and provide programmatic and web interfaces respectively to, one or more application servers 118. The application servers 118 host one or more application(s) 120. The application servers 118 are, in turn, shown to be coupled to one or more database servers 124 that facilitate access to one or more databases 126 or data stores, such as NoSQL or non-relational data stores.

The marketplace applications 120 may provide a number of marketplace functions and services to users that access the networked system 102. While the applications 120 are shown in FIG. 1 to form part of the networked system 102, in alternative embodiments, the various applications 120 may form part of a service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various applications 120 could also be implemented as standalone software programs, which do not necessarily have networking capabilities. Additionally, although FIG. 1 depicts machines 130, 110, and 112 as being coupled to a single networked system 102, it will be readily apparent to one skilled in the art that machines 130, 110, and 112, as well as applications 128, 106, and 108, may be coupled to multiple networked systems. For example, the application 128, 106, and 108 may be coupled to applications 120, such as payment applications associated with multiple payment processors (e.g., Visa, MasterCard, and American Express).

The web client 106 accesses the various applications 120 via the web interface supported by the web server 116. Similarly, the programmatic client 108 accesses the various services and functions provided by the applications 120 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more promotional, marketplace or payment functions that are supported by the relevant applications of the networked system 102.

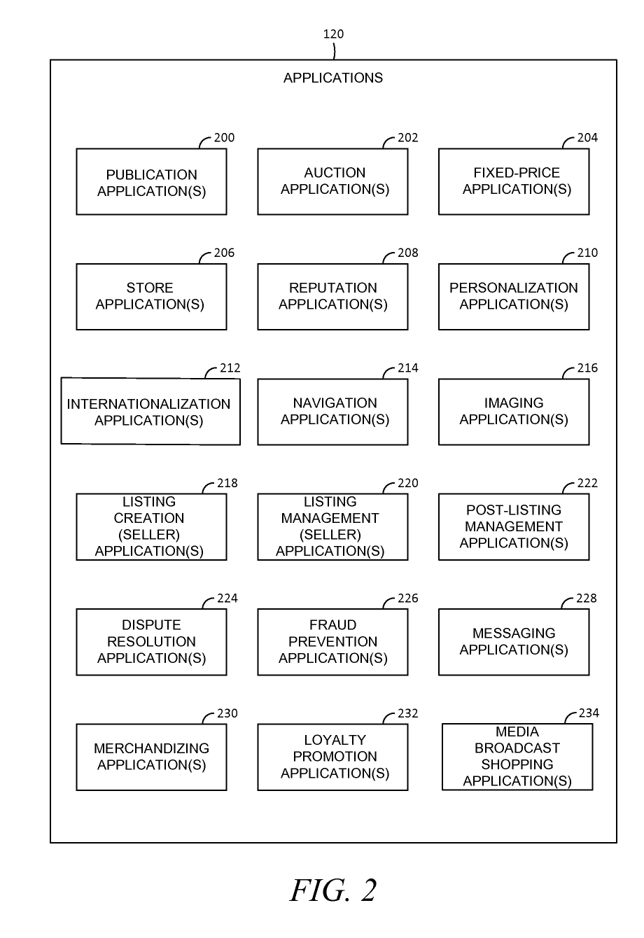

FIG. 2 is a block diagram illustrating multiple applications 120 that, in various example embodiments, are provided as part of the networked system 102. The applications 120 may be hosted on dedicated or shared server machines (not shown) that are communicatively coupled to enable communications between server machines. The applications 120 themselves are communicatively coupled (e.g., via appropriate interfaces) to each other and to various data sources, so as to allow information to be passed between the applications 120 so as to allow the applications 120 to share and access common data. The applications 120 may furthermore access one or more databases 126 via the database servers 124.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable keyword searches of listings published via the networked system 102. A browse application may allow users to browse various category, catalogue, or inventory data structures according to which listings may be classified within the networked system 102. Various other navigation applications may be provided to supplement the search and browsing applications.

In order to make listings available via the networked system 102 as visually informing and attractive as possible, the marketplace applications 120 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. The listing creation application 218 and listing management applications 220 may allow sellers to manage listing in bulk (e.g., in a single operation, such as by an uploading of a file) and provide templates for sellers to manage category-specific, vendor-specific, or general-type-specific (e.g., catalog or ticket) listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of operations in an attempt to settle a dispute. In the event that the dispute cannot be settled via the guided procedures, the dispute may be escalated to a third-party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102. These messages may, for example, advise users regarding the status of listings at the networked system 102 (e.g., providing “outbid” notices to bidders during an auction process or providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotions points for each transaction established and/or concluded with a particular seller, and may be offered a reward for which accumulated loyalty points can be redeemed.

Media broadcast shopping application(s) 234, described in more detail below, may allow users to quickly and easily shop for items presented within or otherwise associated with a media broadcast that the user is currently consuming or has consumed in the past.

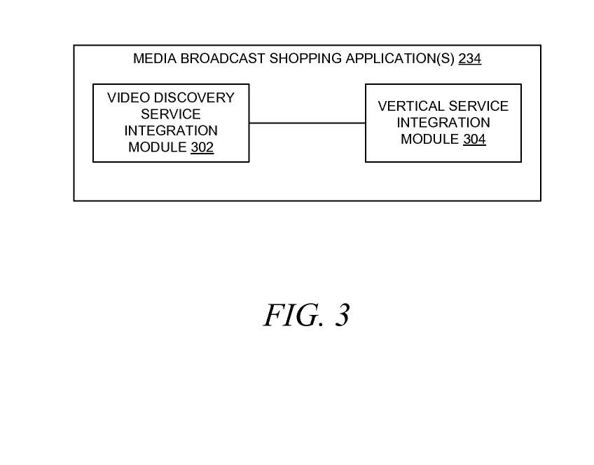

FIG. 3 is a block diagram illustrating example modules of the media broadcast shopping application(s) 234. A video discovery service integration module 302 may be configured to generate or receive information regarding items that are presented within or otherwise associated with a media broadcast. A vertical service integration module 304 may be configured to generate or receive information regarding items associated with a vertical market, such as a sports memorabilia market or a fashion market, that are presented within the broadcast. In various embodiments, the media broadcast shopping application(s) 234 may receive information from a third-party system about the items presented within or in association with the media broadcast and then correlate the received information about the items with information included in a database of listings of the items. In various embodiments, the listings may be maintained by sellers of the items with respect to the network-based publication system. The media broadcast shopping application(s) 234 may then integrate the information about the listings of the items, as well as provide a user interface for enabling the user to interact with the items, for presentation in a display (e.g., a primary display, such as a television set, and a secondary display, such as a tablet PC, smart phone, etc.) that is associated with the media broadcast.

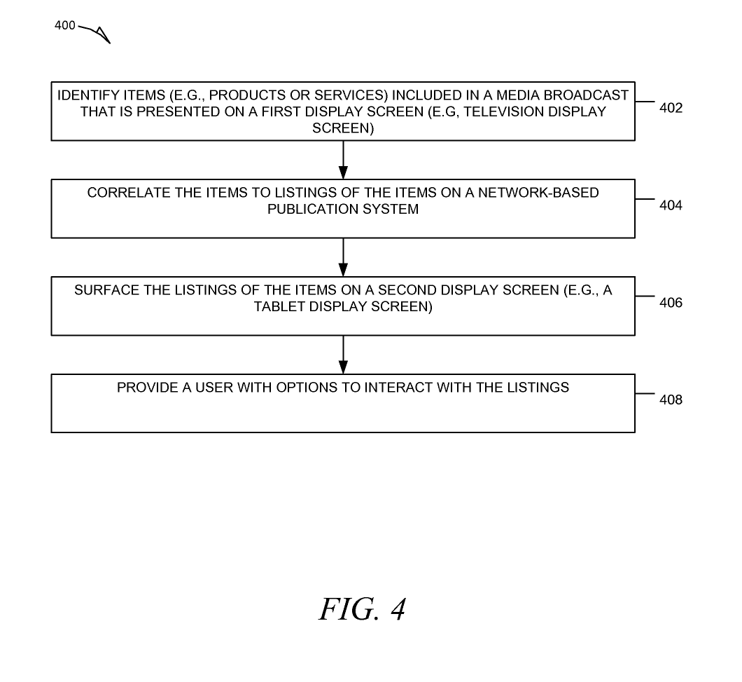

FIG. 4 is a flowchart illustrating an example method 400 of allowing a user to interact with listings associated with items presented within or otherwise associated with a media broadcast. In various embodiments, the method 400 may be implemented by the media broadcast shopping application(s) 234. At operation 402, the video discovery service integration module 302 may identify items (e.g., products or services) presented within or otherwise associated with a media broadcast (e.g., a television show, radio broadcast, podcast, or other media stream) delivered to a first display screen (e.g., a television display screen) or presented, for example, through playback of a file containing a recording of the media broadcast stored in a file on a device associated with the first display screen.

At operation 404, the video discovery integration module 302 may correlate the identified items to listings of the items on a network-based publication system. For example, if the item identified is sports jersey associated with a player of a game that is the subject of the media broadcast, the video discovery integration module 302 may correlate the sports jersey with one or more listings of the sports jersey on the network-based publication system.

At operation 406, the video discovery integration module 302 may surface the listings of the items on a second display screen (e.g., a table PC display screen).

At operation 408, the video discovery integration module 302 may provide the user with options to interact with the listings. For example, the user may be provided with options to purchase the item, place a bid on the item, or watch the item as offered in one or more of the listings. Or the user may be provided with options to display the information about one or more of the listings on the first display or solicit advice from additional users with regard to an action that the user should perform with respect to the items or the listings of the items.

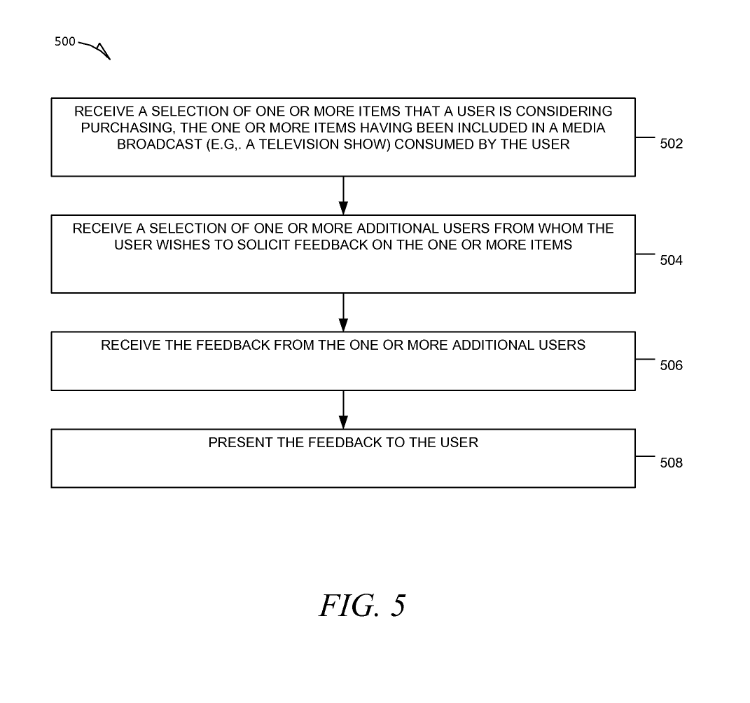

FIG. 5 is a flowchart illustrating an example method 500 of allowing a user to request feedback from additional users with respect to an action that the user may perform with respect to an item that the user selects in conjunction with a consumption of a media broadcast. In various embodiments, the method 500 may be implemented by the media broadcast shopping application(s) 234. At operation 502, the video discovery service integration module 302 may receive a selection of one or more items that are, for example, presented during a media broadcast that the user is consuming or has consumed, that the user is considering performing an action with respect to (e.g., a purchasing, bidding, or watching action).

At operation 504, the video discovery service integration module 302 may receive a selection of one or more additional user from whom the user wishes to solicit feedback on the selection of the one or more items. In various embodiments, the user may select the one or more additional users from a list of friends of the user with respect to the network-based publication system or a third-party system (e.g., Facebook or other social networking system). In various embodiments, the solicitation of the feedback may come in the form of a poll to the additional users. For example, the additional users may be asked whether the user should purchase the item, place a bid on the item, or perform another action with respect to a listing of the item. In various embodiments, the poll may have various possible answers and thus be more complex than a simple yes or no poll. In various embodiments, the poll may allow the additional users to specify reasons why they provided particular answer or otherwise provide the user with information that may be helpful to the user in making the decision with respect to the item. In various embodiments, the user may be able to formulate a survey question as well as possible answers to the survey question. Additionally, the user may be able to specify when the survey or poll will be available and for how long the poll will be available for the additional users to response.

At operation 506, the video discovery service integration module 302 receives the feedback from the one or more additional users.

At operation 508, the video discovery service integration module 302 presents the feedback to the user. For example, in the case of a yes or no poll regarding whether the user should purchase the item, the user may be presented with a number of the additional users that have indicated that the user should purchase the item and a number of the additional users that have indicated that the user should not purchase the item. In the case of a more complex survey, the user may be provided with a number of users who selected each of the possible survey answers.

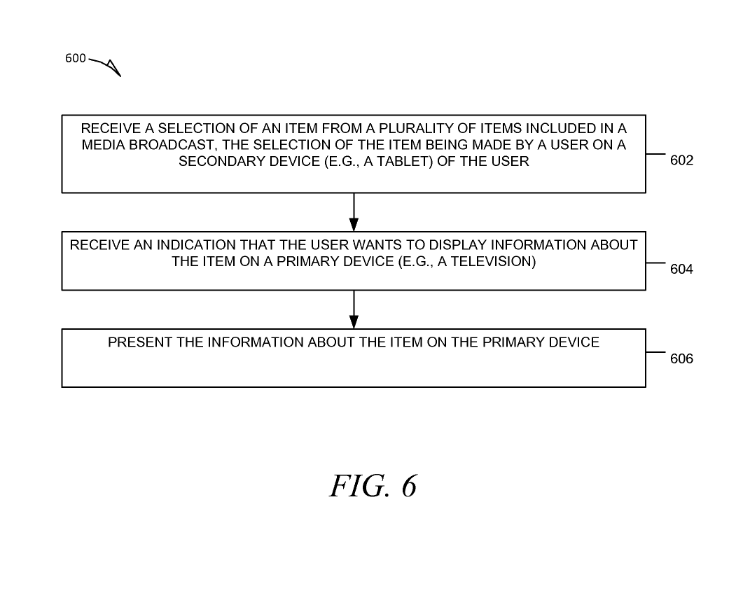

FIG. 6 is a flowchart illustrating an example method 600 of allowing a user to present on a primary device information about an item or a listing of an item received on a secondary device. In various embodiments, the method 600 may be implemented by the media broadcast shopping application(s) 234. At operation 602, the video discovery service integration module 302 may receive a selection of an item from a plurality of items presented within or associated with a media broadcast, the selection of the item being made by a user on a secondary device (e.g., a tablet) of the user.

At operation 604, the video discovery service integration module 302 may receive a request from the user to display information about the item on a primary device of the user (e.g., a television).

At operation 606, the video discovery service integration module 302 transmits the request to the primary device or otherwise processes the request to allow the primary device to present the information about the item on the primary device.

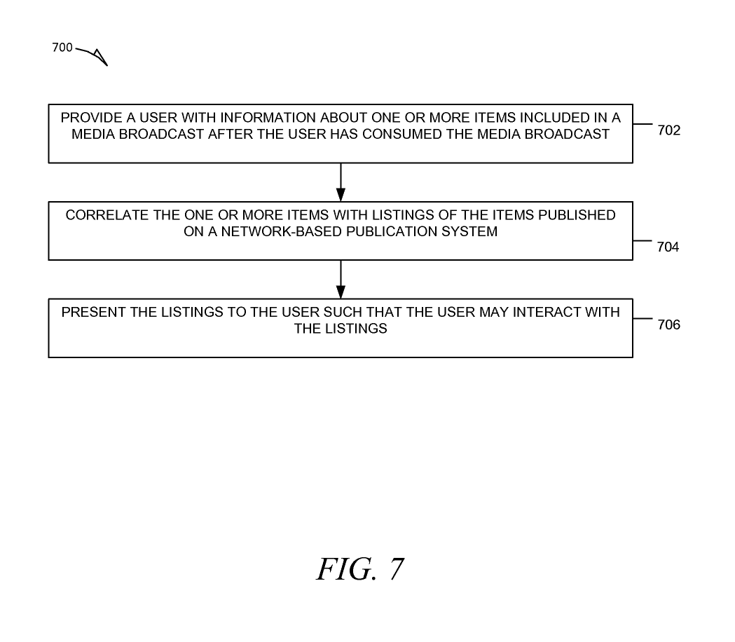

FIG. 7 is a flowchart illustrating an example method 700 of allowing a user to present on a primary device information about an item or a listing of an item received on a secondary device. In various embodiments, the method 700 may be implemented by the media broadcast shopping application(s) 234. At operation 702, the video discovery service integration module 302 provides the user with information about one or more items included in a media broadcast after the user has consumed the media broadcast.

At operation 704, the video discovery service integration module 302 correlates the one or more items with listings of the items published on a network-based publication system. In various embodiments, the listings are maintained with respect to the network-based publication system by sellers of the items.

At operation 706, the video discovery service integration module 302 presents the listings to the user such that the user may interact with the listings. For example, the user may be able to place bids on or immediately purchase an item featured in a listing. Or the user may be able to watch a listing of an item (e.g., to be notified whether the item has reached a certain price point). In various embodiments, the user may also be presented with options to display the information about the item on a separate display screen or request opinions or users with respect to the items, as discussed herein.

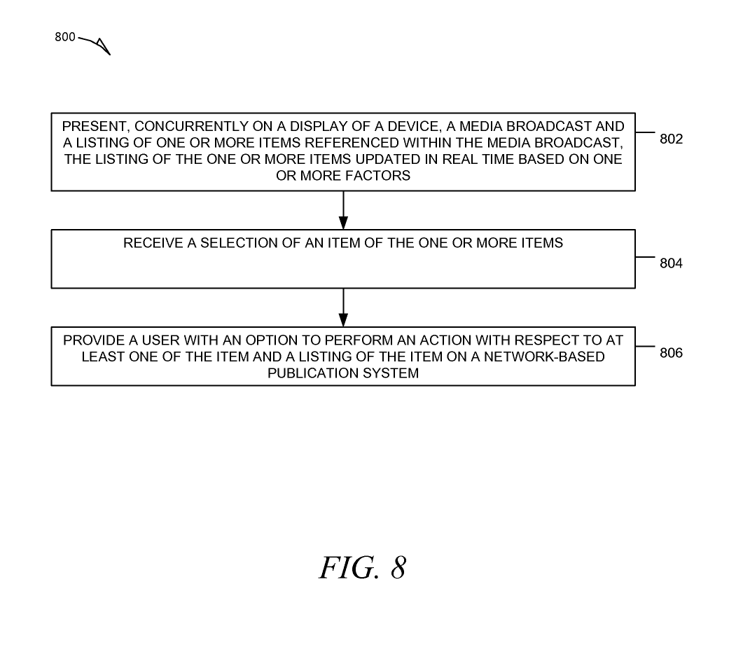

FIG. 8 is a flowchart illustrating an example method 800 of simultaneously presenting a media broadcast with information about items associated with the media broadcast on a display screen. In various embodiments, the method 800 may be implemented by the media broadcast shopping application(s) 234. At operation 802, the video discovery service integration module 302 presents, concurrently on a display of a device, a media broadcast and a listing of one or more items referenced within the media broadcast or otherwise associated with the media broadcast. In various embodiments, the listing of the one or more items is updated in real time based on one more factors. Factors may include a recentness with which content in the media broadcast associated with the item was consumed by the user, a relevance of the item to subject matter of the media broadcast, a prominence with which the item is featured within the media broadcast, an importance placed by a seller of the item with respect to the importance of the item within the media broadcast (e.g., based on a payment received from the seller), and so on.

At operation 804, the video discovery service integration module 302 receives a selection of an item of the one or more items from the user.

At operation 806, the video discovery service integration module 302 provides the user with an option to perform an action with respect to at least one of the item and a listing of the item on the network-based publication system. For example, the user may be provided with any of the options described above with respect to operation 706 of FIG. 7.

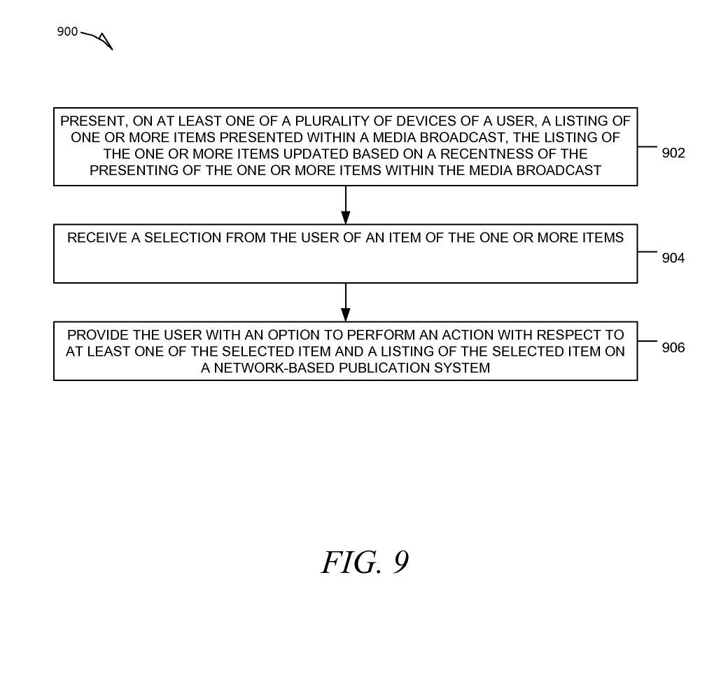

FIG. 9 is a flowchart illustrating an example method 900 of presenting a listing of items corresponding to a media broadcast as it relates to a vertical market (e.g., in a sports memorabilia or fashion market) associated with the media broadcast. In various embodiments, the method 900 may be implemented by the vertical service integration module 304. At operation 902, the vertical service integration module 304 presents, on at least one of a plurality of devices of the user, a listing of one or more items presented within the media broadcast that relate to the vertical market. In various embodiments, the listing of the one or more items is updated based on a recentness of the presenting of the one or more items within the media broadcast in relation to the current point of consumption of the user within the media broadcast.

At operation 904, a selection is received from the user of an item of the one or more items.

At operation 906, the vertical service integration module 304 provides the user with an option to perform an action with respect to the one or more items or a listing of the items on the network-based publication system. For example, the user may be provided with any of the options described above with respect to operation 706 of FIG. 7.

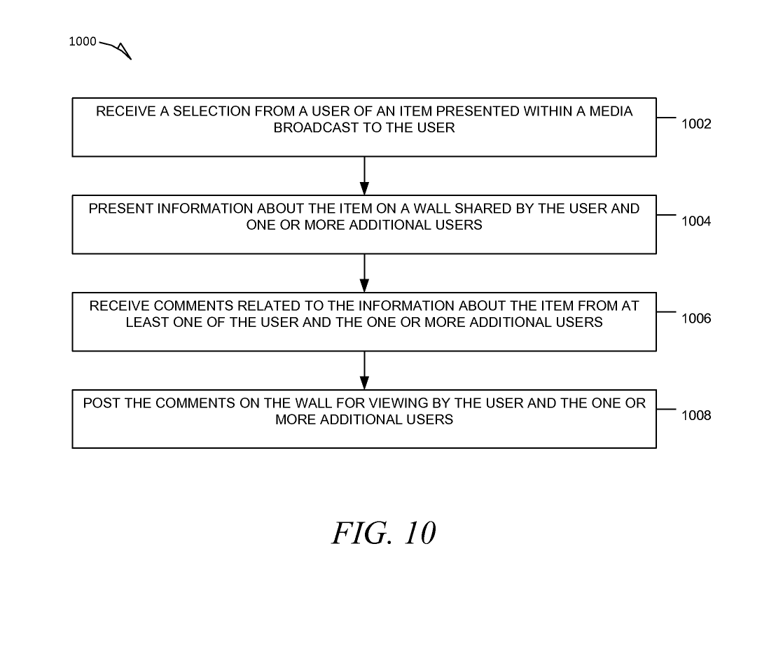

FIG. 10 is a flowchart illustrating an example method 1000 of simultaneously presenting a media broadcast with information about items associated with the media broadcast on a display screen. In various embodiments, the method 800 may be implemented by the media broadcast shopping application(s) 234. At operation 1002, the video discovery service integration module 302 receives a selection from a user of an item presented within the media broadcast or associated with the media broadcast.

At operation 1004, the video discovery service integration module 302 presents information about the item on a wall shared by the user and one or more additional users.

At operation 1006, the video discovery service integration module 302 receives comments related to the information about the item from at least one of the user and the one or more additional users.

At operation 1008, the video discovery service integration module 302 posts the comments on the wall for viewing by the user and the one or more additional users.

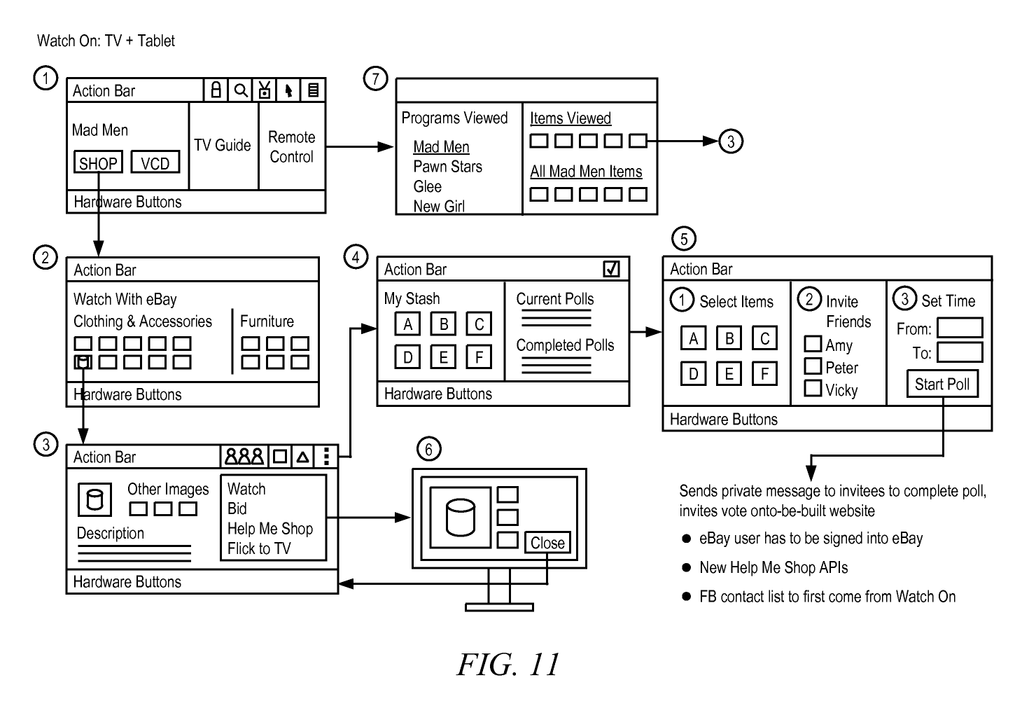

FIG. 11 is a mockup of a user interface that allows a user to simultaneously watch a media broadcast on a first device (e.g., a television) and shop for items related to the media broadcast on a second device (e.g., a tablet PC or smart phone). At 1, the user interface shows content (e.g., an episode of Made Men) that is currently available for streaming to the first device. The user interface may present an index to available shows (e.g., a television guide) and a remote control (e.g., an IP-based television remote control). Additionally, the user interface may include a shop button. Although the Shop button is depicted at 1 as being included in the user interface, in various embodiments, the shop button may be integrated into the hardware buttons of the device. For example, a television remote control may include a shop button that would trigger the presentation of the shopping user interface on the second device.

At 2, based on, for example, on the user pressing the Shop button at 1, the user interface displays items associated with a currently streaming media broadcast. Such items may be categorized by vertical market (e.g., clothing and accessories, furniture, and so on). The user may select an item to receive more information about the item or to be presented with options to perform an action with respect to the item. Additionally or alternatively, at 7, based, for example, on the user pressing a button at 1 to access information from previously viewed media broadcasts, the user interface includes a list of media broadcasts previously viewed by the user (e.g., Mad Men, Pawn Stars, Glee, New Girl, and so on). When the user selects a show, the user interface lists all of the items that the user viewed while watching the media broadcast or all of the items associated with the media broadcast.

At 3, based on, for example, the user selecting an item at 2 or 7, the user interface presents more information about the selected item. For example, the user may be presented with information about the item derived from listings of the item on a network-based publication system, such as a description of the item, images of the item, and so on. The user may also be presented with various options that the user may perform with respect to the item, such as watching the item or a listing of the item on the network-based publication system, bidding on an item featured in a listing, asking additional users for help in shopping for the item, selecting a display screen on which to display the information about the item, or any of the various options described herein.

At 4, based on, for example, the user selecting a Sharing icon at 3, the user interface may present a list of items that the user has indicated an interest in and for which the user may request more information from additional users. The user interface may also present a list of current or past polls or surveys posted by the user to one or more additional users, as described above.

At 5, based on, for example, the user selecting particular items from the list of items that the user previously expressed an interest in, the user interface may present the selected particular items and provide the user with options to invite friends to comment on the items, initiate a poll or survey of additional users to provide advice pertaining to the items, and so on. In various embodiments, the user interface may enable the user to set a start time and an end time for the polling. In various embodiments, a private message may be sent to invitees to complete the poll.

At 6, based on, for example, the user pressing a button at 3 to change displays, the user interface may present the information about the selected item on the first display.

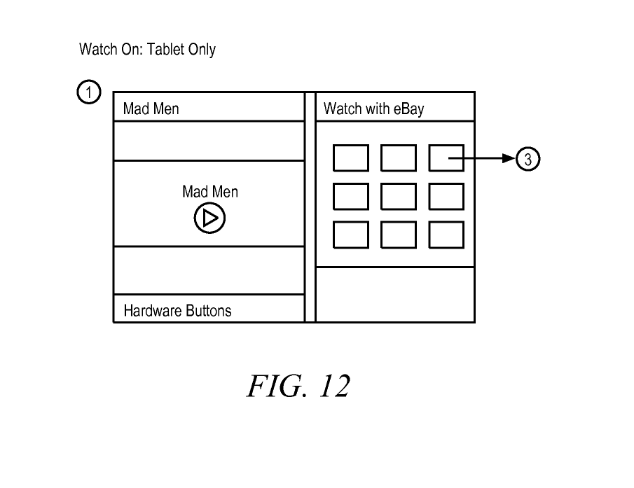

FIG. 12 is a mockup of a user interface that allows a user to simultaneously watch a media broadcast on a first device and shop for items related to the media broadcast on a single device (e.g., a tablet PC). At 1 of FIG. 12, the media broadcast (e.g., Mad Men) is presented in a first window or window pane and information about items presented in association with the media broadcast is presented in a second window or window pane. When a user selects a button corresponding to one of the items, the user interface presents the information about the item, as depicted at 3 of FIG. 11.

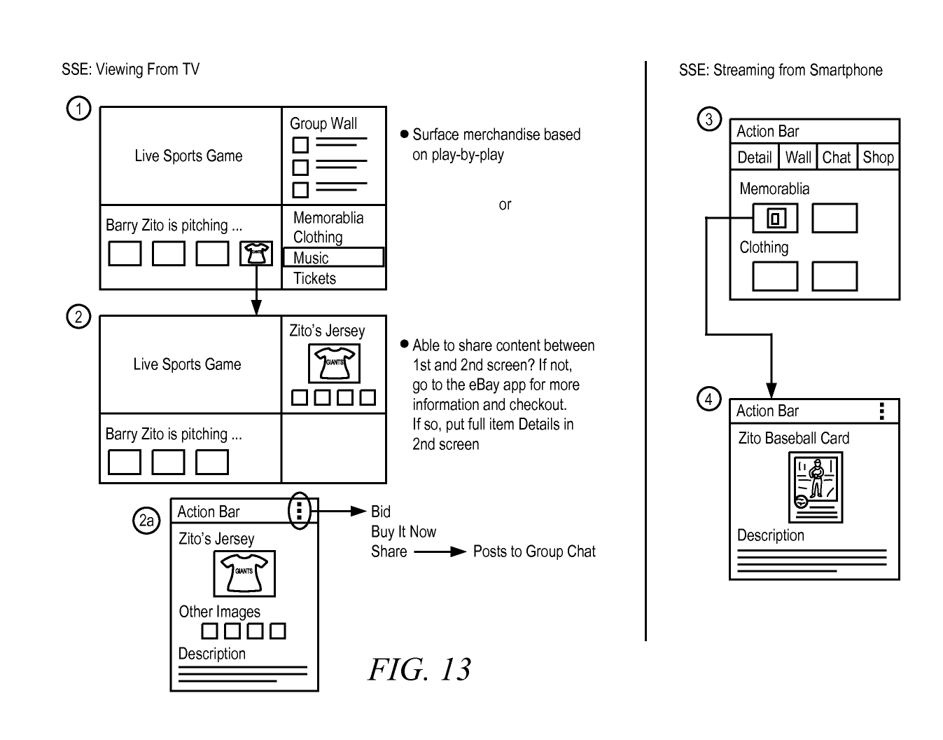

FIG. 13 is a mockup of a user interface that allows a user to shop for items while watching a live sporting event. At 1 of FIG. 13, the user interface presents the live sporting event, information about a context of the live sporting event (e.g., Barry Zito is pitching), and items associated with the context of the live sporting event (e.g., Bary Zito items on eBay). The user interface also presents a group wall that includes items related to the live sporting event that have been flagged by the user or one or more additional users for discussion. In various embodiments, the items may be organized into categories associated with the live sporting event, such as memorabilia, clothing, music, or tickets).

At 2 of FIG. 13, based on, for example, the user selecting an item presented at 1 of FIG. 13, the user interface presents more information about the item in a region on the edges of the display screen. At FIG. 2a, in various embodiments, based on the user having an additional device configured to receive the information about the item, the user interface presents the information about the item on the display screen of the additional device. In various embodiments, as depicted at 3 and 4, the items may be selected and information displayed about the items on the display screen of the additional device instead of on the display screen on which the live sporting game is displayed.

Although depicted as software buttons (e.g., buttons that are presented as part of the user interface), the various buttons shown in FIGS. 11-13 may also be implemented as hardware buttons (e.g., as part of the hardware buttons on a remote control).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

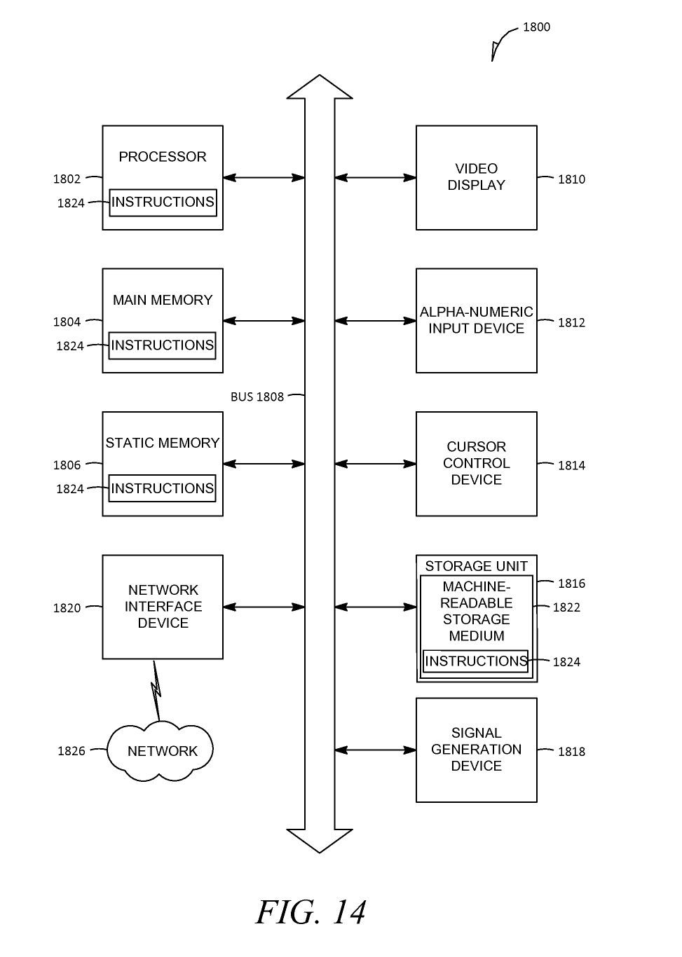

FIG. 14 is a block diagram of machine in the example form of a computer system 1800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a user interface (UI) navigation (or cursor control) device 1814 (e.g., a mouse), a storage unit 1816, a signal generation device 1818 (e.g., a speaker) and a network interface device 1820.

The storage unit 1816 includes a machine-readable medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media. The instructions 1824 may also reside, completely or at least partially, within the static memory 1806.

While the machine-readable medium 1822 is shown in an example embodiment to be a single medium, the term “machine-readable medium” may include a single medium or multiple media (e.g., a centralized or distributed database, and/or associated caches and servers) that store the one or more instructions 1824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1826 may be one of the networks 104.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
detecting a transmitting of a media broadcast;
identifying that an item is being presented within the media broadcast;
identifying a correspondence between the item that is being presented within the media broadcast and a listing of the item on a network-based publication system; and
presenting a user with an option to, during the transmitting of the media broadcast, perform an action pertaining to the listing of the item on the network-based publication system.

2. The method of claim 1, wherein the action includes at least one of placing a bid corresponding to the listing of the item on the network-based publication system and placing an order corresponding to the listing of the item on the network-based publication system.

3. The method of claim 1, wherein the action includes engaging in a chat with another user, the chat pertaining to the item that is being presented to the user within the media broadcast and the listing of the item on the network-based publication system.

4. The method of claim 1, wherein the presenting of the user with the option includes presenting a user interface element on a mobile device of the user, the mobile device of the user being separate from the consumption device of the user, the consumption device being a device with which the user is consuming the media broadcast.

5. The method of claim 1, wherein the identifying of the correspondence is based on an identification of a brand of the item that is being presented to the user within the media broadcast and an identification of a seller of the brand of the item on the network-based publication system.

6. The method of claim 1, wherein the item is an item of clothing worn by a person appearing in the media broadcast and the listing pertaining to the item is a listing of a copy of the item of clothing as being for sale.

7. The method of claim 6, wherein the media broadcast is a live sporting broadcast, the item of clothing is a jersey worn by a player participating in the live sporting broadcast, and the listing pertaining to the item is a replica of the jersey.

8. A system comprising:
one or more processors configured to:
detect a transmitting of a media broadcast;
identify that an item is being presented within the media broadcast;
identify a correspondence between the item that is being presented within the media broadcast and a listing of the item on a network-based publication system; and
present a user with an option to, during the transmitting of the media broadcast, perform an action pertaining to the listing of the item on the network-based publication system.

9. The system of claim 8, wherein the action includes at least one of placing a bid corresponding to the listing of the item on the network-based publication system and placing an order corresponding to the listing of the item on the network-based publication system.

10. The system of claim 8, wherein the action includes engaging in a chat with another user, the chat pertaining to the item that is being presented to the user within the media broadcast and the listing of the item on the network-based publication system.

11. The system of claim 8, wherein the presenting of the user with the option includes presenting a user interface element on a mobile device of the user, the mobile device of the user being separate from the consumption device of the user, the consumption device being a device with which the user is consuming the media broadcast.

12. The system of claim 8, wherein the identifying of the correspondence is based on an identification of a brand of the item that is being presented to the user within the media broadcast and an identification of a seller of the brand of the item on the network-based publication system.

13. The system of claim 8, wherein the item is an item of clothing worn by a person appearing in the media broadcast and the listing pertaining to the item is a listing of a copy of the item of clothing as being for sale.

14. The system of claim 13, wherein the media broadcast is a live sporting broadcast, the item of clothing is a jersey worn by a player participating in the live sporting broadcast, and the listing pertaining to the item is a replica of the jersey.

15. A non-transitory machine readable storage medium storing a set of instructions that, when executed by at least one processor, causes the at least one processor to perform operations comprising:
detecting a transmitting of a media broadcast;
identifying that an item is being presented within the media broadcast;
identifying a correspondence between the item that is being presented within the media broadcast and a listing of the item on a network-based publication system; and
presenting a user with an option to, during the transmitting of the media broadcast, perform an action pertaining to the listing of the item on the network-based publication system.

16. The non-transitory machine readable storage medium of claim 15, wherein the action includes at least one of placing a bid corresponding to the listing of the item on the network-based publication system and placing an order corresponding to the listing of the item on the network-based publication system.

17. The non-transitory machine readable storage medium of claim 15, wherein the action includes engaging in a chat with another user, the chat pertaining to the item that is being presented to the user within the media broadcast and the listing of the item on the network-based publication system.

18. The non-transitory machine readable storage medium of claim 15, wherein the presenting of the user with the option includes presenting a user interface element on a mobile device of the user, the mobile device of the user being separate from the consumption device of the user, the consumption device being a device with which the user is consuming the media broadcast.

19. The non-transitory machine readable storage medium of claim 15, wherein the identifying of the correspondence is based on an identification of a brand of the item that is being presented to the user within the media broadcast and an identification of a seller of the brand of the item on the network-based publication system.

20. The non-transitory machine readable storage medium of claim 15, wherein the item is an item of clothing worn by a person appearing in the media broadcast and the listing pertaining to the item is a listing of a copy of the item of clothing as being for sale.
